(19) United States
(12) Patent Application Publication
(10) Pub. No.: US 2014/0244349 A1
(43) Pub. Date: Aug. 28, 2014

(54) SYSTEM AND METHOD FOR MOBILE ANALYTICS PLATFORM

(71) Applicant: TRINITY PHARMA SOLUTIONS, LLC, Waltham, MA (US)

(72) Inventors: Zackary King, Bristol, RI (US); Frank Lane, North Andover, MA (US); Don Nguyen, Braintree, MA (US)

(73) Assignee: Trinity Pharma Solutions, LLC, Waltham, MA (US)

(21) Appl. No.: 13/891,571

(22) Filed: May 10, 2013

Related U.S. Application Data
(60) Provisional application No. 61/769,116, filed on Feb. 25, 2013.

(51) Int. Cl. G06Q 30/02

(52) U.S. Cl. CPC G06Q 30/0201
USPC 705/7.29

(57) ABSTRACT

The disclosed technology, in certain embodiments, provides a mobile analytics platform tailored to a specific industry, e.g., the life science/health care industry. This platform presents large amounts of data, organized and displayed as an analytical story on a portable electronic device. The platform may translate large amounts of data to provide insights and answer questions specific to a user's role. The system may take the user through an analytical story that delivers actionable insights, thus making it easy and intuitive to consume large amounts of information.

### Related Applications

This application claims priority to and benefit of, and incorporates herein by reference in its entirety, U.S. Provisional Application No. 61/769,116, filed Feb. 25, 2013.

### FIELD OF INVENTION

This invention relates generally to mobile analytics. More particularly, in certain embodiments, this invention relates to systems and methods for analyzing and presenting sales information, for example, in the science/healthcare industry.

### BACKGROUND

An organization can improve sales operations by understanding the organization's markets and business inside and out. Certain industries, such as the life science industry, have an abundance of market data stored in complex data warehouses. This data may be processed by generic business intelligence solutions; however, these solutions may not provide access to data in a user friendly format to provide industry specific insights. The limitations of traditional systems are amplified as the amount of data, cost pressures, and demand for mobile analytics continue to increase.

For example, in the life sciences industry, a customer is defined as the originator of demand. Originators of demand in the life sciences industry include a wide variety of people in various positions, and each operates under unique circumstances and originates demand for different products.

For example, a health care provider (HCP) may create or influence demand. Generally, an HCP is a physician, but may also be a physician assistant, a nurse practitioner, or other person authorized to practice medicine, write prescriptions or administer medications. A Health Care Organization (HCO) is another originator of demand within the life sciences industry. A health care organization provides health care services and may be an individual or group practice, an individual hospital, a hospital system, or a group purchasing organization. Some HCPs are also affiliated with HCOs. Within HCPs and HCOs there may also be a key opinion leader (KOL). A KOL is a person who influences the therapeutic decisions of HCPs and HCOs. The KOL is generally also an HCP and may or may not practice. A practical example of KOLs is an Oncologist who is considered to be the foremost expert (or one of the foremost experts) in his or her particular field.

Each of these organizations and the various providers that create demand play an important role in driving sales of products in the life sciences industry. There is a need for a business analytics system tailored to a specific industry that accounts for the circumstances particular to that industry.

### SUMMARY

The disclosed technology, in certain embodiments, provides a mobile analytics platform tailored to a specific industry, e.g., the life science/health care industry. This platform presents large amounts of data, organized and displayed as an analytical story on a portable electronic device. The platform may translate large amounts of data to provide insights and answer questions specific to a user's role. The system may take the user through an analytical story that delivers actionable insights, thus making it easy and intuitive to consume large amounts of information.

In certain embodiments, the disclosed technology provides sales analytics, including performance management and business planning reports, on a portable computing device. The business planning reports may be directed to a field sales organization including sales representatives, managers, and executives. In certain embodiments, performance management and business planning reports measure performance against defined objectives regardless of whether the objectives are compensated. Performance management and business planning reports may guide tactical sales activities by presenting data surrounding opportunities, performance management, market dynamics, and customer targeting. The reports may connect the overall performance objectives to tactical actions.

In certain embodiments, the user experience is tailored specifically to each customer including his/her role, goals, and objectives. In certain embodiments, the system consolidates an organization's data and insights into one place to provide longitudinal and historical views of performance even as the institution's data, market, and metrics evolve. The system, in certain embodiments, provides a bird's eye view of an organizations entire business, including sales, marketing, and management, in a single interface.

The disclosed technology, in certain embodiments, includes receiving, at a portable computing device from a server via a network, sales information, wherein the sales information comprises sales data of one or more accounts associated with one or more sales representatives; presenting, by a processor of the portable computing device, on a display of the portable computing device, (a) at least a portion of the sales data, wherein the portion of the sales data is associated with at least one of the one or more accounts, and (b) a control for managing the sales data, wherein the control for managing the sales data is configured upon selection to activate processing of the portion of the sales data according to one or more metrics identified via the control; receiving selection of the control for managing data, wherein selection of the control activates processing of the portion of the sales data according to at least one metric of the one or more metrics; and presenting, by the processor, on the display of the portable device, a subset of the sales data processed according to metrics provided via the control.

In certain embodiments, activating processing includes issuing a request to the server to process the portion of the sales data according to the at least one metric. In certain embodiments, the one or more metrics include at least one member selected from the group consisting of: (i) percentage of regional growth, (ii) percentage of regional revenue, (iii) sales opportunities, (iv) geography, (v) market share, (vi) a comparison of two or more accounts, (vii) growth over a specified period by at least one of market, product, competitor, and market share, and (viii) decline over a specified period by at least one of market, product, competitor, and market share.

In certain embodiments, the control is configured for user selection of a particular metric of the one or more metrics. In certain embodiments, the control includes one or more widgets for selection of the one or more metrics, wherein the one or more widgets comprise at least one member selected from the group consisting of: a button, a hyperlink, a drop-down list, a list box, a combo box, a check box, a radio button, a cycle button, a spinner, a menu, an icon, and a link.

In certain embodiments, the disclosed technology includes receiving, by the processor, selection of a particular account of the one or more accounts; and presenting, by the processor, a profile of the particular account, wherein the profile includes sales information associated with the particular account.

The disclosed technology, in certain embodiments, includes accessing sales information, wherein the sales information comprises sales data of a plurality of accounts associated with a plurality of sales representatives; applying, by a processor of a computing device, one or more rules to the sales information to identify one or more accounts of the plurality of accounts, wherein the one or more accounts are associated with the sales information that satisfy at least one of the one or more rules; creating, by the processor, one or more alert instances, wherein each alert instance of the one or more alert instances includes a respective identification of the respective account of the one or more accounts; issuing, by the processor, the one or more alert instances to software application accounts of one or more sales representatives associated with the one or more accounts, wherein the one or more alert instances are configured to generate an alert via a respective software application installed upon a respective portable computing device; receiving, by the processor, from a portable computing device via a network, a request responsive to a first alert instance of the one or more alert instances, wherein the request comprises a request for information associated with the first alert instance; and providing, by the processor, to an application executing on the portable device, sales data associated with the first alert instance.

In certain embodiments, applying the one or more rules to the sales information further includes: identifying, by the processor, a respective threshold associated with each rule of the one or more rules; and comparing, by the processor, one or more values associated with the sales information to the respective threshold associated with each rule of the one or more rules to determine whether the sales information satisfies at least one of the one or more rules.

In certain embodiments, the one or more rules include at least one member selected from the group consisting of: accounts that have the greatest opportunity, accounts declining, accounts growing, and contact frequency within a certain period of time. In certain embodiments, the sales data associated with the first alert instance includes at least one member selected from the group consisting of: (i) percentage of regional growth, (ii) percentage of regional revenue, (iii) sales opportunities, (iv) geography, (v) market share, (vi) market volume change, (vii) contribution to geography in market value, (viii) market share change, (ix) comparison of two or more accounts, (x) growth over a specified period by market, product, competitor, or market share, and (xi) decline over a specified period by market, product, competitor, or market share.

In certain embodiments, each alert instance of the one or more alert instances includes an alert trigger description, wherein the alert trigger description identifies at least one of an identification of the one or more rules triggered, and a reason an alert was issued.

The disclosed technology, in certain embodiments, includes a non-transitory computer readable medium storing a set of instructions that, when executed by a processor, cause the processor to: receive, at a portable computing device from a server via a network, sales information, wherein the sales information comprises sales data of one or more accounts associated with one or more sales representatives; present, by a processor of the portable computing device, on a display of the portable computing device, (a) at least a portion of the sales data, wherein the portion of the sales data is associated with at least one of the one or more accounts, and (b) a control for managing the sales data, wherein the control for managing the sales data is configured upon selection to activate processing of the portion of the sales data according to one or more metrics identified via the control; receive selection of the control for managing data, wherein selection of the control activates processing of the portion of the sales data according to at least one metric of the one or more metrics; and present, by the processor, on the display of the portable device, a subset of the sales data processed according to metrics provided via the control.

The disclosed technology, in certain embodiments, includes a non-transitory computer readable medium storing a set of instructions that, when executed by a processor, cause the processor to: access sales information, wherein the sales information comprises sales data of a plurality of accounts associated with a plurality of sales representatives; apply, by a processor of a computing device, one or more rules to the sales information to identify one or more accounts of the plurality of accounts, wherein the one or more accounts are associated with the sales information that satisfy at least one of the one or more rules; create, by the processor, one or more alert instances, wherein each alert instance of the one or more alert instances includes a respective identification of the respective account of the one or more accounts; issue, by the processor, the one or more alert instances to software application accounts of one or more sales representatives associated with the one or more accounts, wherein the one or more alert instances are configured to generate an alert via a respective software application installed upon a respective portable computing device; receive, by the processor, from a portable computing device via a network, a request responsive to a first alert instance of the one or more alert instances, wherein the request comprises a request for information associated with the first alert instance; and provide, by the processor, to an application executing on the portable device, sales data associated with the first alert instance.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 illustrates an example method for providing sales analytics on a portable computing device;

FIG. 2 is an example graphical user interface for displaying a compensated metric of attainment for a sales representative;

FIG. 3 is an example graphical user interface for providing performance analytics;

FIG. 4 illustrates an example method for providing alerts to a portable computing device;

FIG. 5 is an example graphical user interface for providing performance analytics that allows a user to assess where they should focus efforts;

FIG. 6 is an example graphical user interface for providing a payer landscape for a region or territory to enable a user to determine an approach for the region or specific payers;

FIG. 7 is an example graphical user interface for providing a list of customers and for sorting and filtering a customer list to understand performance and identify opportunities at an account level;

FIG. 8 is an example graphical user interface for providing a comprehensive view of a customer to determine performance in depth and for the purpose of deciding how to best engage a customer during a call;

FIG. 9 shows a block diagram of an exemplary cloud computing environment;

FIG. 10 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the disclosed technology provides a mobile analytics platform tailored to a specific industry. The platform presents large amounts of data, organized and displayed as an analytical story on a portable electronic device while taking into account the unique circumstances surrounding and structure of a specific industry. In some implementations, customers are segmented into logical groupings based on common attributes or behavior dimensions. An attribute describes a customer's composition such as specialty whereas a behavioral segment is based on activities such as market volume. Summarizing performance metrics across these customer segments enables understanding of performance in digestible chunks of information.

In some implementations, the disclosed technology includes sales analytics, including performance management and business planning reports tailored to a specific industry, on a portable computing device. The business planning reports may be directed to a field sales organization including sales representatives, first line managers, second line managers, and executives. In some implementations, performance management and business planning reports measure performance against defined objectives regardless of whether the objectives are compensated. In some implementations, performance management and business planning reports guide tactical sales activities. The reports may connect the overall performance objectives to tactical actions.

In some implementations, measures used in reports fall into two broad categories: sales and activities. Sales may include products that are purchased and a wide range of measures. Specific sales measures include whether the product is a prescription, units (e.g. the number of boxes, pills, vials, etc.), and patients. In some implementations, patients is a unit of measure derived from units by dividing by the standard of care over a defined time period (e.g. 60 units of a therapy intended to be a 30 day supply that requires 2 pills/day is 1 patient). In some implementations, market share is derived from sales and defined as the percent of sales for a given product divided by the total market. Understanding the market size and product positioning is important in understanding opportunity. In some implementations, there are two ways to increase sales of the promoted product: (i) increase the market size holding share constant, or (ii) take market share by converting competitor sales to the promoted product.

In some implementations, measures used in reports include incentive compensation (IC) measures. IC measures may be determined based on actual sales divided by a goal. IC measures may be applicable to sales volume or market share programs. In some implementations, volume goals are utilized by immature products or therapeutic classes with few direct competitors. In some implementations, market share goals are utilized in mature markets. In some implementations, IC measures include commission information. A commission may be an amount a sales representatives receives in terms of a fixed dollar value or percentage of all sales transactions. In some implementations, IC measures include alternative IC plans because the types of IC measures vary dramatically. Alternative IC plans may include a forced rank where each territory is ranked and pay is based on relative rank (e.g. the highest rank will take the most pay and lowest, the least). Alternative IC plans may include compensation based on the distance of sales from the national average.

In some implementations, there are two measures of sales activities: calls and samples. Sales activities may be concentrated on the highest opportunity customers; however, often activities are focused on the highest value customers demonstrating a lack of clarity between value and opportunity. A sales organization may be most concerned with the return on investment (ROI) associated with sales activities to ensure that resource (resources include sales representative time and samples) allocation is optimized. Sales metrics are compared to the benchmarks of national or regional averages. Sales metrics may include sales calls (e.g. promotional engagement with a customer or group of customers) and call goals (e.g. the number of times that the sales representative should visit that customer over a defined period of time). Sale metrics may include samples. In many therapeutic classes, sales representatives are able to provide customers with samples to start patients on a product prior to filling a prescription. Samples may not be associated with a goal and the sales representative may have the freedom to allocate as he/she sees fit making it even more important to correlate the samples with results.

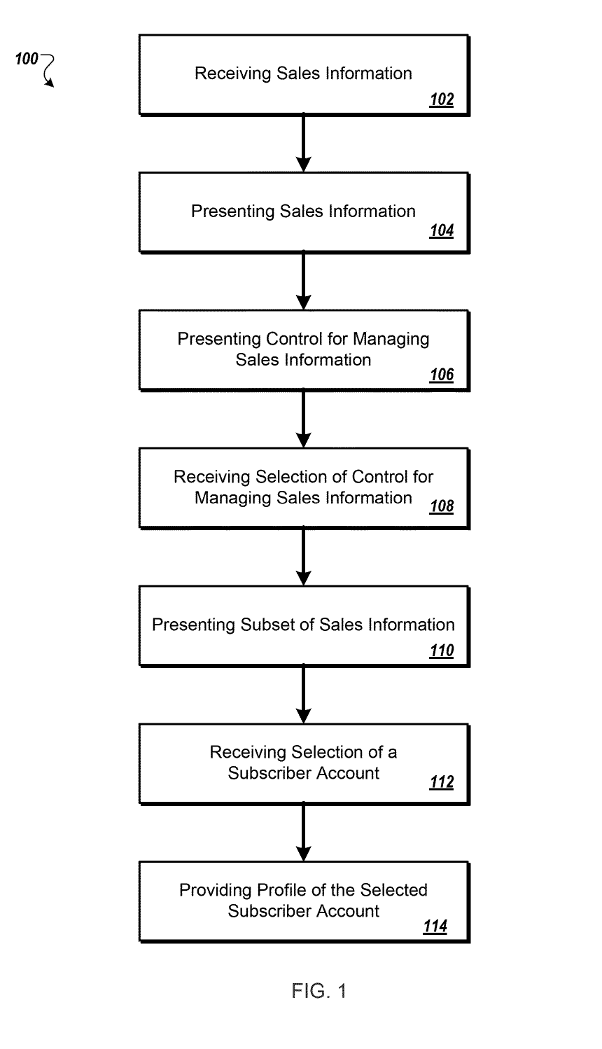

FIG. 1 illustrates, in accordance with some implementations, a method (100), performed by a processor of a computing device, for providing sales analytics on a portable computing device. The computing device includes various forms of digital computers, desktops, workstations, personal digital assistants, servers, blade servers, mainframes, or portable computing device such as mobile computing devices, tablets, personal digital assistants, cellular telephones, smart-phones, laptops, in-vehicle entertainment devices or other vehicle computer systems, and other similar computing devices. In some implementations, method (100) is implemented a cloud-based system that enables users to make tactical and strategic decisions grounded in data.

In some implementations, the method (100) includes receiving, at a portable computing device, sales information (102). In some implementations, the sales information is received from a server via a network. The sales information may include sales data of one or more accounts associated with one or more sales representatives.

In some implementations, the method (100) includes presenting, by a processor of the portable computing device, on a display of the portable computing device, a portion of the sales data (104). The portion of the sales data may be associated with one or more accounts. In some implementations, a control for managing the sales data is presented on the display of the portable computing device (106). The control may be configured for user selection of one or more metrics. The control for managing the sales data may be configured upon selection to activate processing of the portion of the sales data according to one or more metrics identified via the control.

In some implementations, the metrics include at least one of a: (i) percentage of regional growth, (ii) percentage of regional revenue, (iii) sales opportunities, (iv) geography, (v) market share, (vi) a comparison of two or more accounts, (vii) growth over a specified period by at least one of market, product, competitor, and market share, and (viii) decline over a specified period by at least one of market, product, competitor, and market share. In some implementations, the control is one or more widgets that allow for selection of the one or more metrics. Widgets may be one or more buttons, hyperlinks, drop-down lists/menus, list boxes, combo boxes, check boxes, radio buttons, cycle buttons, spinners, menus, icons, links, or any combination thereof

In some implementations, the method (100) includes receiving, by a processor of the computing device, selection of the control for managing data (108). The selection of the control may activate processing of the portion of the sales data according to metrics identified via the control. In some implementations, activating processing includes issuing a request to a server to process the portion of the sales data according to the one or more metrics identified via the control.

In some implementations, the method (100) includes presenting, by the processor, on the display of the portable device, a subset of the sales data processed according to metrics provided via the control (110). The presentation of the data may be in the form of performance management and business planning reports. The reports may be directed to a field sales organization including sales representatives, first line managers, and second line managers. In some implementations, performance management and business planning reports measure performance against defined objectives regardless of whether the objectives are compensated.

In some implementations, the method (100) includes receiving, by the processor, selection of a particular account of the one or more accounts (112). In some implementations, the method (100) includes presenting, by the processor, a profile of the particular account (114). The profile may include sales information associated with the particular account.

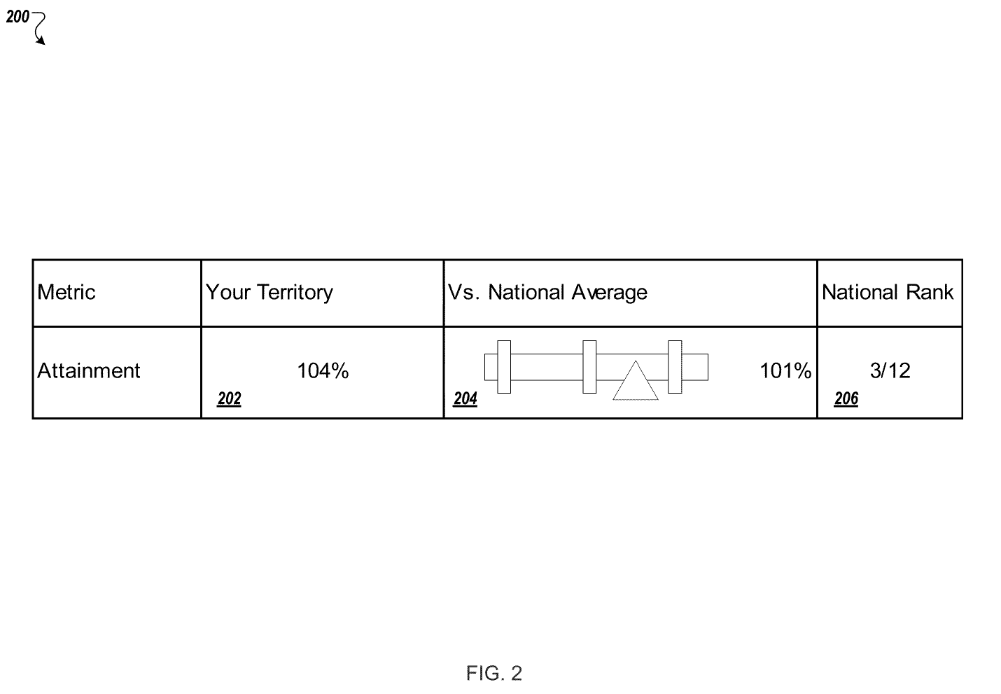

FIGS. 2, 3, and 5-7 are screenshots of example graphical user interfaces for displaying and interacting with analytics software. In some implementations, the objective of the analytics software is to guide the user from overall performance to the actions and tactics that drive performance. In some implementations, the flow is from performance to a call to action. The primary means of influence may be the sales calls and/or samples. In some implementations, secondary actions provide insight into other non-core influence factors such as distribution, as applicable. Secondary influence factors may be alert-oriented, as opposed to multiple layers of navigation, to indicate that there is a problem that the representative needs to address.

Sales organizations may have compensated and non-compensated objectives. The compensated objectives may be the focus of the organization and may be sales based and tangible. Some examples include: goals based IC programs, comparisons against peer territories or averages where payouts may be rank based, a calculation compared to an average, or commission based. Non-compensated objectives may be provided to the sales organization and focus on the recommended strategy. These objectives may be highly correlated to performance An example of a non-compensated objective is to call on high-decile customers five times per quarter. There may be no repercussion for choosing not to call on these high-decile prescribers at the recommended frequency unless the sales representative is not performing well on compensated objectives.

In some implementations, key performance indicators (KPIs) are designed to map precisely to an objective and to indicate whether the performance is good or bad. In some implementations, KPIs are categorized for each metric whether it is objective such as greater than or equal to 100% is good and less than 100% is bad, or whether it is a comparison to average derived benchmarks. Categories may include at least one of good, okay, bad, positive, neutral, negative, numeric scores, or other similar categories.

FIG. 2 is an example graphical user interface (GUI) 200 for displaying a compensated metric of attainment for a sales representative. In some implementations, GUI 200 includes the sales representative's attainment 202. In this example, the sales representative's attainment is 104%. In some implementations, the attainment 202 is color coded to indicate a category for the metric. In this example, the attainment may be color coded green because the attainment is above 100%. In some implementations, GUI 200 includes a comparison to the benchmark of peer territories or national average 204. In this example, the national average is 101%, thus the sales representative is doing better than the national, but is not the highest ranked. In some implementations, GUI 200 includes a national rank 206. In this example, the national rank shows the sales representative is ranked third of a total of twelve sales representatives and that there is opportunity to improve to become the top ranked sales representative

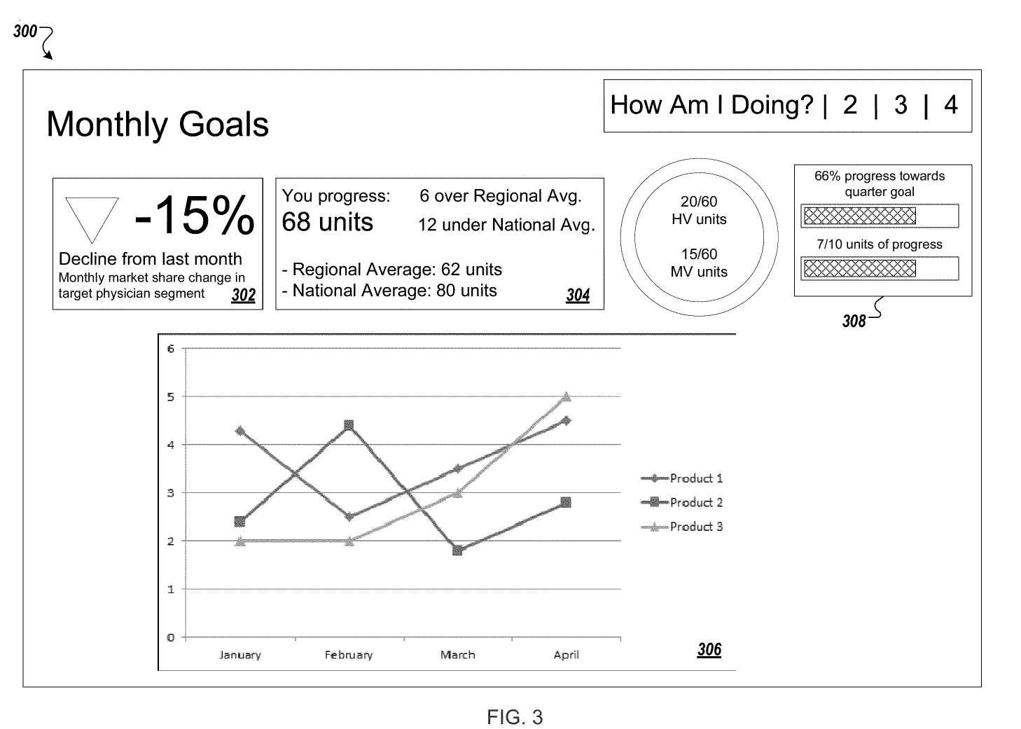

FIG. 3 is an example GUI 300 for providing performance analytics. In some implementations, GUI 300 provides information related to whether a sales representative is meeting non-compensated goals. GUI 300, in some implementations, provides information related to how much a sales representative is being paid. Calculation of compensation payouts may be more than just the sales performance metrics that comprise the program and includes eligibility. In some implementations, GUI 300 provides actual estimated payouts. In some implementations, GUI 300 provides the compensation metrics and may provide other views that include the IC program design and payout tables that enable the user to calculate compensation at a 100% eligible. GUI 300, in some implementations, provides information related to how a sales representative compares to his/her peers, how the sales representative is performing relative to his/her minimum and/or maximum, and what the sales representative can do to earn higher compensation.

In some implementations, GUI 300 provides performance reports for managers. Manager performance reports capture the same information as discussed above for each of the sales representatives reporting to a given manager. In some implementations, manager reports are shown in a list format.

In some implementations, GUI 300 includes a specific compensation metric 302 that provides an indication of performance over a given period of time. GUI 300 may include supporting values that are used to derive the specific compensation metric. GUI 300 may include graphical representations 308 of a sales representative's performance for a given period of time or progress towards a specified goal. GUI 300 may include a comparison to benchmarks of peer territory performance.

In some implementations, GUI 300 includes a market scorecard 306. The market scorecard 306 may include one or more charts, graphs, plots, or other indication of performance data. The market scorecard 306 may provide KPIs by major segments and a comparison to benchmarks. The market scorecard 306 may identify market volume charge, market volume percent change, product performance as defined by market share or market share change, and/or product performance as defined by product volume and/or volume change.

In some implementations, GUI 300 includes performance of non-compensated objectives. Non-compensated objectives include call metrics such as reach (e.g. the number of targets called once or more for a given number of targets), frequency (the number of times reached customers are called), and/or calls per day (total number of calls per the number of working days for a given period of time). In some implementations, non-compensated objectives include sample metrics such as the total number of samples dropped and/or the number of samples per customer (e.g. total samples per the number of reached customers).

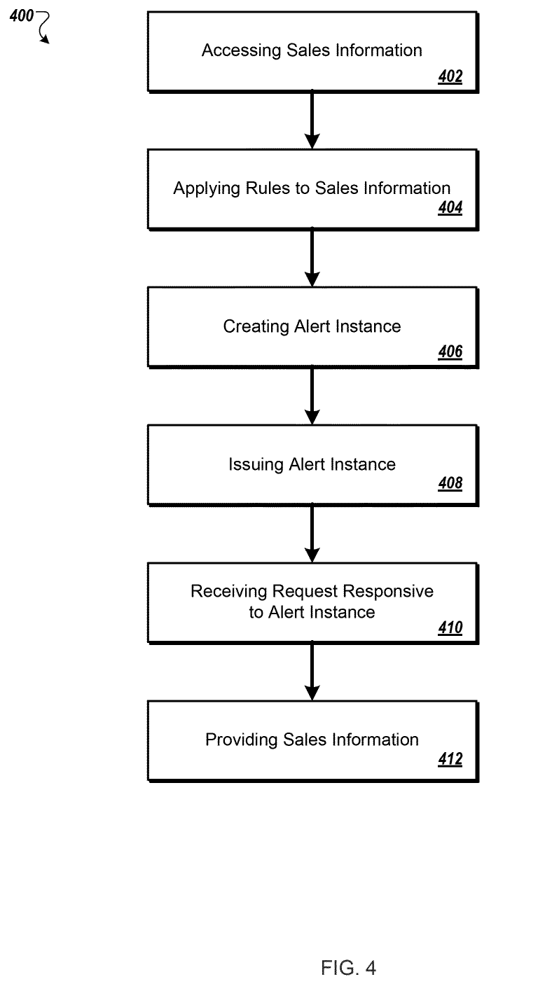

FIG. 4 illustrates, in accordance with some implementations, a method (400), performed by a processor of a computing device, for providing alerts to a portable computing device. In some implementations, alerts are immediate calls to action that show a sales representative issues, wins, and/or opportunities. In some implementations, alerts are only provided for customers, issues, wins, and/or opportunities if they have a significant impact on the overall performance for the sales representative. Alerts may be used to identify which customers (e.g. health care providers, organizations, or outlets) are changing behavior, which customers represent the greatest opportunity, whether market share of a sales representative's product is declining or growing, whether a market is growing or declining, or if there is a customer that has not been called recently. In some implementations, the method (400) is implemented on a remote computing device that interacts with a portable computing device. In some implementations, the method (400) is implemented on a portable computing device that interacts with a remote computing device.

In some implementations, method (400) includes accessing sales information (402). The sales information may include sales data of a plurality of accounts associated with a plurality of sales representatives.

In some implementations, the method (400) includes applying, by a processor of a computing device, one or more rules to the sales information (404) to identify one or more accounts of the plurality of accounts. Applying one or more rules to the sales information may include identifying, by the processor, a respective threshold associated with each rule of the one or more rules and comparing, by the processor, one or more values associated with the sales information to the respective threshold associated with each rule of the one or more rules to determine whether the sales information satisfies at least one of the one or more rules. The accounts identified are associated with the sales information that satisfy at least one of the one or more rules.

In some implementations, one or more alert instances (406) are created by the processor. Each alert instance may include a respective identification of the respective account of the one or more accounts, an alert name, an alert ID, an alert trigger description, and/or information regarding contribution to geography in market volume, market volume change, market share, market share change, leading competitors, residing competitors, and/or last called date information.

In some implementations, the method (400) includes issuing, by the processor, the one or more alert instances (408) to software application accounts of one or more sales representatives associated with the one or more accounts. The alert instances may be configured to generate an alert via a respective software application installed upon a respective portable computing device. In some implementations, the alert instance issued includes an alert trigger description that identifies at least one of an identification of the one or more rules triggered, and a reason an alert was issued.

In some implementations, alert instance issued appear on a GUI of a portable computing device as an alert instance GUI. The alert instance GUI may be selected by a user of the portable computing device. In some implementations, method (400) includes receiving, by the processor, from a portable computing device via a network, a request responsive to a first alert instance of the one or more alert instances (410). The request may include a request for information associated with an alert instance. In some implementations, method (400) includes providing, by the processor, to an application executing on the portable device, sales data associated with the alert instance (412). In some implementations, the sales data associated with the alert instance includes: (i) percentage of regional growth, (ii) percentage of regional revenue, (iii) sales opportunities, (iv) geography, (v) market share, (vi) market volume change, (vii) contribution to geography in market value, (viii) market share change, (ix) comparison of two or more accounts, (x) growth over a specified period by market, product, competitor, or market share, and/or (xi) decline over a specified period by market, product, competitor, or market share.

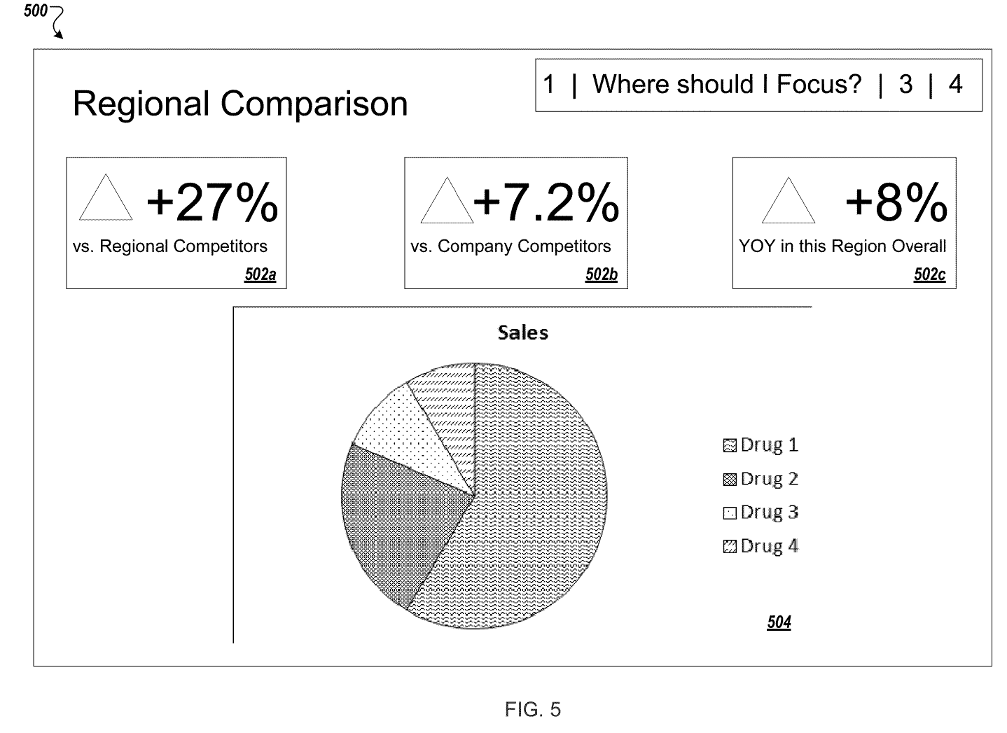

FIG. 5 is an example GUI 500 for providing performance analytics. In some implementations, GUI 500 provides information related to understanding performance of a focused on groups of accounts. The groups of accounts may be separated along attribute values, behavioral categories, and performance/opportunity. GUI 500 may enable to user to determine how to approach the territory and may serve as the conduit between top line performance and determination of the accounts that are driving performance and should be reviewed. GUI 500 may provide information regarding which groups of accounts are performing well and which have opportunity, what are the volume and market share trends by account group, what are the competitor products in the market doing, where is a sales representative focusing his/her attentions, and/or what percentage of the total geography does this a displayed segment represent.

In some implementations, GUI 500 includes market segments that may be filtered by segmentation groups, such as product group, decile group, and/or specialty group. GUI 500, in some implementations, provides information for display 502 including various metrics including market share, market share by volume, trends over a given period of time, summarizes of specified time periods, and/or comparisons versus regional competitors, company competitors, and/or year over year (YOY) in a given region overall. In some implementations, GUI 500 includes one or more graphs 504, plots, and/or charts that display sales data to a user. For example, GUI 500 may include a pie chart as shown in FIG. 5 that depicts sales data for four different products as a percentage of total sales for a given period of time.

In some implementations, data may be filtered, cut, or sorted by different segments and/or product views. In some implementations, product views include the promoted product and competitor. In some implementations, a product view will link to the segmentation view applying the same filters. Thus, a user may identify custom groupings of customers that are driving performance and then view each account individually to better understand performance.

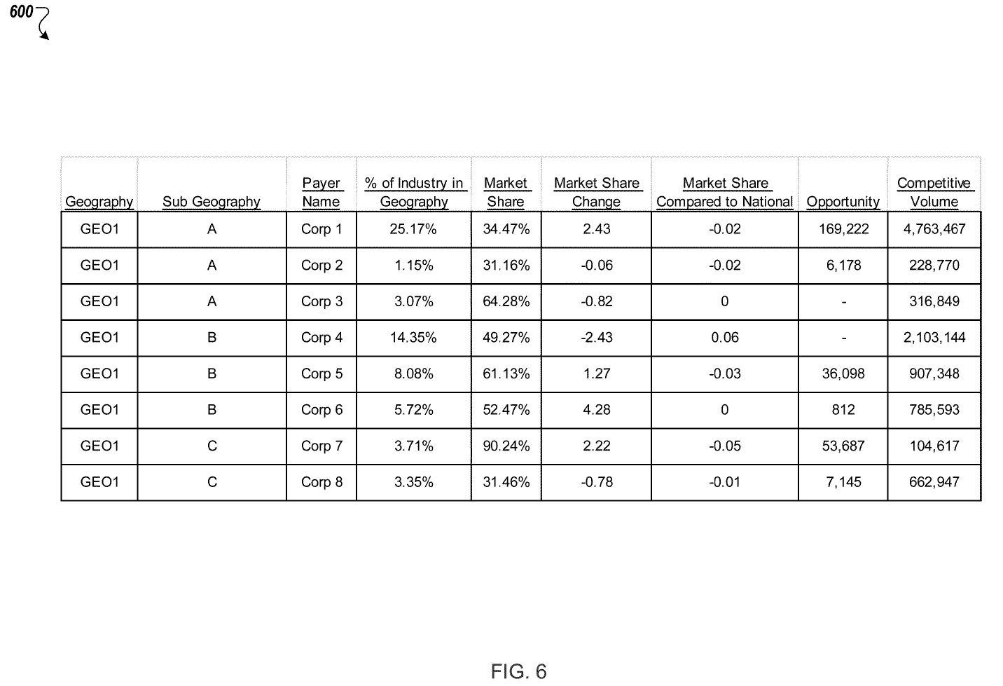

FIG. 6 is an example GUI 600 for providing a payer landscape for a geography to enable a user to determine an approach for the region or specific payers. In some implementations, GUI 600 provides information regarding who the major payers and how are they performing for a given region or sub-region. In some implementations, GUI 600 provides information regarding which are the top payers, how much does each comprise of a given sales representatives total sales, are there any payers that have under or over-indexed market share, how does the payer performance in the territory compare to that of the nation, which payers are growing as a percent of a given sales representatives geography, what are the top and rising competitor products for each top payer, whether the payer prefers one product or another which may influence the message the sales representative chooses, and/or whether there are any payer changes that require a given sales representative's attention. GUI 600 may include various metrics including the top payers in geography, including each payers rank and name, market contribution to geography (e.g. during the last six months), market share and market share changes (e.g. over the last three months), comparison of market share in a geography to a national average for a payer, leading competitors, rising competitors, and/or payer market size changes (e.g. three months versus immediate previous three months). GUI 600 may link a segmentation view that filters sales data and provides all customers that are associated with that payer. The segmentation view may auto sort in descending order by market volume in that payer.

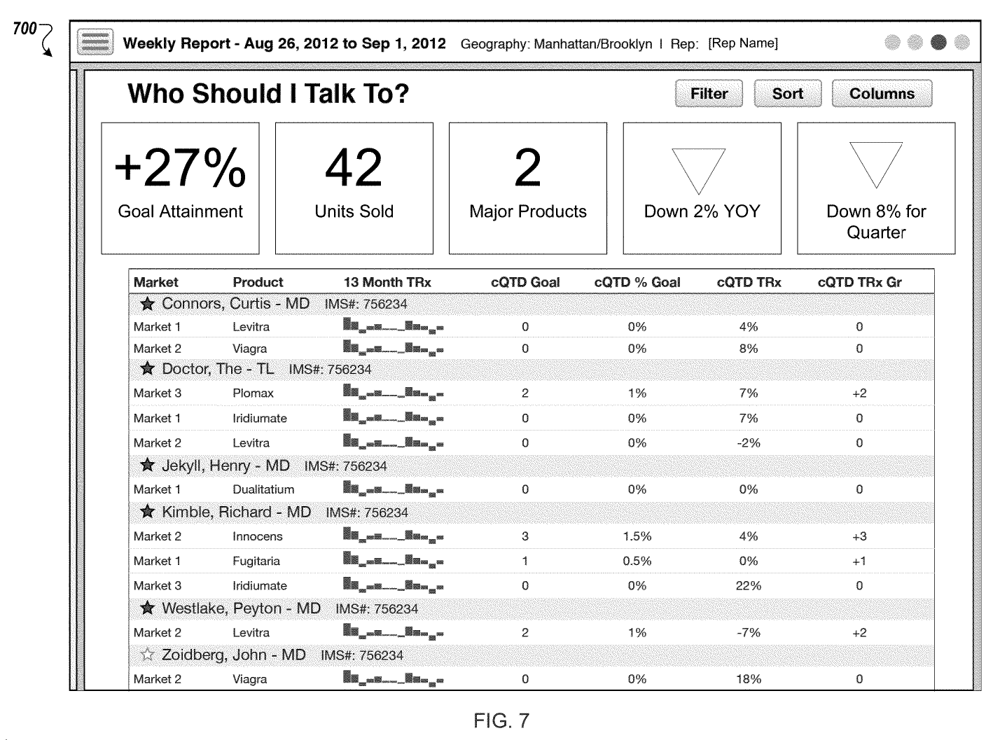

FIG. 7 is an example GUI 700 for providing a list of customers and for sorting and filtering a customer list to understand performance and identify opportunities at an account level. GUI 700 is an example of a segmentation view as described in relation to FIG. 6.

In some implementations, GUI 700 provides information that allows a user to determine how this filtered data set compares to the user's geography total, how individual customers compare to the filter total and geography total, which HCPs represent the largest opportunity, who are the largest growers/ decliners by market, product, competitor and market share, which HCPs have market share that is under-indexed by customer group, and/or which HCPs have market share that is under-indexed by payer.

The information provided on GUI 700 may be associated with a specific customer. The information may include (i) demographics such as customer specialty, segmentation metrics, and/or target status, (ii) market data such as total volume of sales, sales changes/trends, and/or customer contribution to the user's territory (e.g. customer sales per geography sales, (iii) market share of a promoted product including current value and/or changes/trends in market share, (iv) promoted product volume including current value and/or changes/trends in market share, (v) the top payers by market value (e.g. payer percentage of total HCP, HCP market share within a payer, and/or HCP market share within a payer less payer market share within a sales representative's territory, (vi) competitor product market share, and/or (vii) calls and samples information including last call date, number of calls in a given period of time, and/or number of samples provided to customer during a specified period of time. In some implementations, GUI 700 allows a user to sort or filter by any of the attributes or metrics specified above. In some implementations, a user may select a customer to view a customer profile.

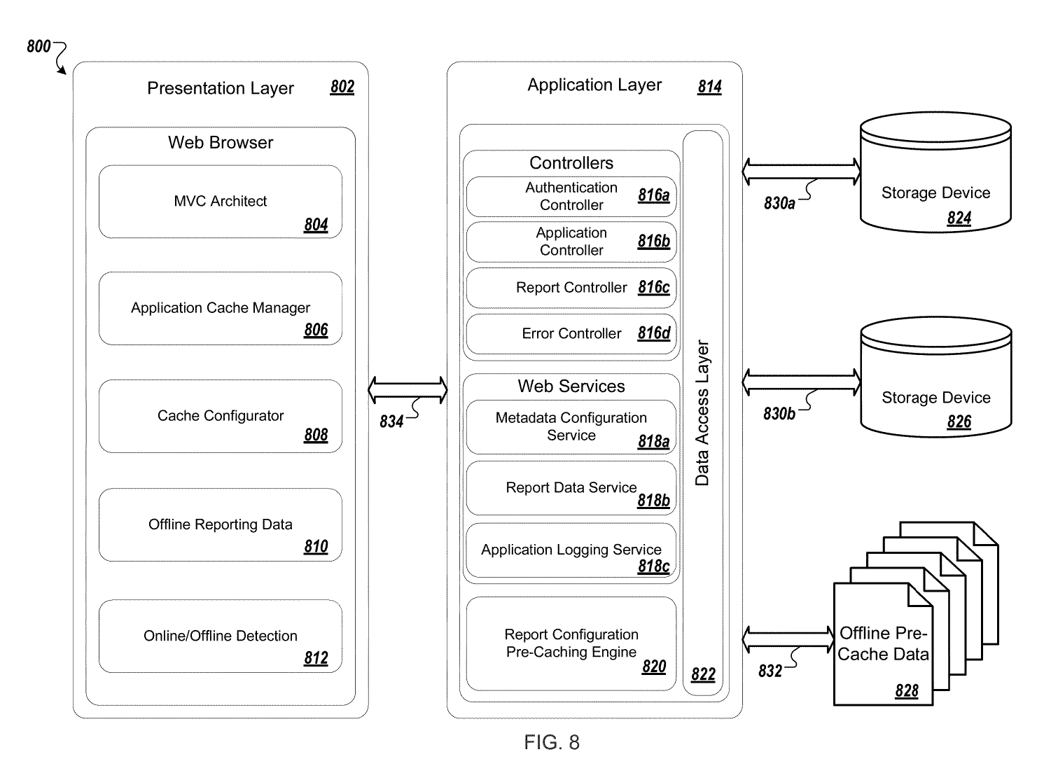

FIG. 8 is an example GUI 800 for providing a comprehensive view of a customer to determine performance in depth and for the purpose of deciding how to best engage a customer during a call. In some implementations, GUI 800 provides information that allows a user to determine where is the customer located, with whom is the customer affiliated (e.g. an institution), what are the key attribute values as applicable (e.g. behavioral segment and/or specialty), what is the composition of the managed care profile of the provider, what is the prescribing/purchasing pattern of a HCP, whether a customer is prescribing/purchasing promoted products or competitor products, how many calls and samples has the customer been provided, and/or whether the customer shows any promotional response.

In some implementations, the information provided on GUI 800 includes customer demographics such as address, specialty, affiliations, and/or office staff The information provided on GUI 800 may include a behavior profile that includes information related to the purchasing of the customer such as the value of the customer to a territory (e.g. a percent contribution or rank), product preference (e.g. a market share pie chart), and/or practice size and growth information as indicated by market volume.

In some implementations, the information provided on GUI 800 includes customer trends. Customer trends may include an interactive chart that shows market and product trends with a comparison to activity so that a sales representative can assess promotional response. Trends may show sales over time and may be based on market volume and product level market share by new and total prescriptions, calls, and/or samples. The information provided on GUI 800 may include a managed care profile for the customer's practice.

FIG. 8 is a diagram of an example architecture for providing sales analytics, including performance management and business planning reports, on a portable computing device. In some implementations, the disclosed technology includes a presentation layer 802. The presentation layer may be a client side layer. In some implementations, the presentation includes a web browser. In some implementations, the presentation layer 802 also includes model, view, and control (MVC) architect 804, an application cache manager 806, a cache configurator 808, offline reporting data 810, and/or an online/offline detection module 812.

In some implementations, the MVC architect 804 decouples the visualization of information from the information's function and data. The MVC architect 804 provides highly configurable report views that may be set by a user of the disclosed technology including a sales representative, manager, and/or administrator.

In some implementations, the application cache manager 806 handles application cache manifests and images management. The application cache manager 806 detects and refreshes a local cache when a new version is available. In some implementations, the cache configurator 808 manages report layout and metadata cache. In some implementations, cache configurator 808 allows a user to specify report data access and downloadable dataset access for offline use. In some implementations, offline reporting data 810 stores data according to user configurable settings for offline access. In some implementations, the online/offline detection module 812 provides client side online/offline detection control, offline data synchronization and storage management, and offline report configuration.

In some implementations, presentation layer 802 communicates with an application layer 814 via a network 834. In some implementations, application layer 814 is server side and presentation layer 802 is client side. In some implementations, the communication is based on the hypertext transfer protocol or secure hypertext transfer protocol. In some implementations, application layer 814 includes controllers 816 such as an authentication controller 816a, application controller 816b, report controller 816c, and/or error controller 816d. In some implementations, controllers 816 control user login logic, manage server side application logics and configurations, dynamically build chart and data view metadata objects to be used in the report presentation layer, and/or handle application error logging.

In some implementations, the disclosed technology includes an application layer 814. In some implementations, application layer 814 includes web services 818. Web services 818 may include a configuration metadata service 818a, a report data service 818b, and/or an application logging service 818c. Web services 818 may manage connections with one or more databases, broker and serialize data requests and transfers between the databases and the application operating on the client side, and/or providing a user session logging data service. In some implementations, application layer 814 includes a report configuration pre-caching engine 820. The report configuration pre-caching engine 820 may be a standalone engine to generate report configuration cache. The report configuration pre-caching engine 820 may communicate with offline pre-cache data 828 stored in a database. In some implementations, report configuration data is stored locally and refreshed as needed.

In some implementations, the disclosed technology includes a data layer 836. In some implementations, data layer 836 includes data storage devices such as an application database 824, one or more report databases 826, and/or offline pre-cache data storage 828. In some implementations, application database 824 stores use information, session, and user statistics. Application database 824 may store basic application layout and content panels. Application database 824 may provide application error tracking. In some implementations, data layer 836 provides abstract data connections management, manages connections pool and timeout, and/or handles query parameters configuration and communication. In some implementations, one or more databases in the data layer 836 store (i) panel, chart, and grid configuration data, (ii) predefined filter, sort, column show/hide data, and/or (iii) report configuration data.

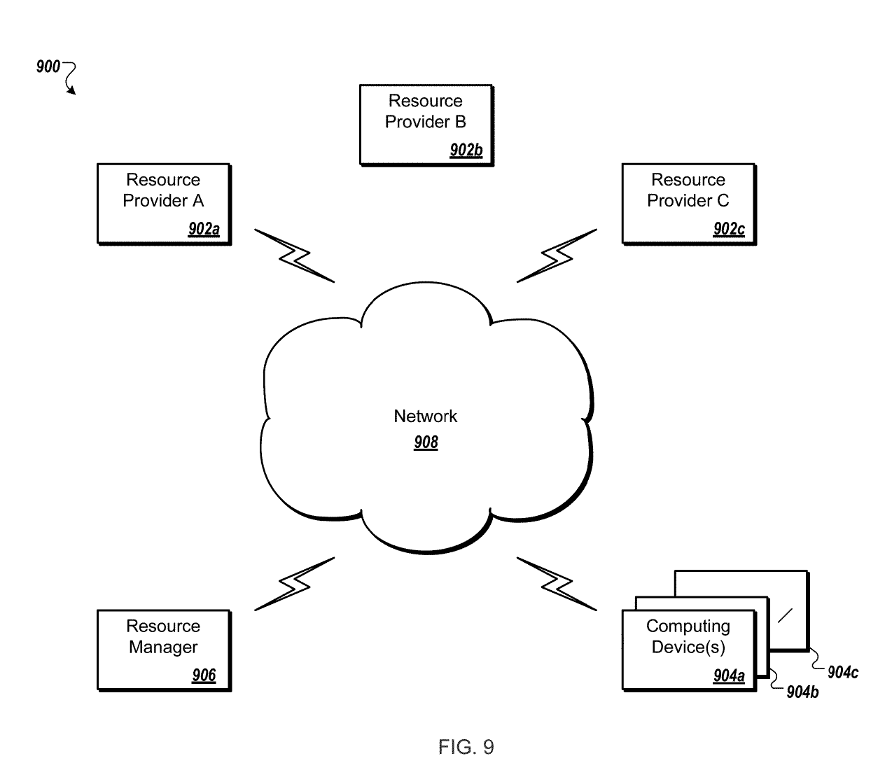

As shown in FIG. 9, an implementation of a network environment 900 for use in providing sales analytics, including performance management and business planning reports, on a portable computing device is shown and described. In brief overview, referring now to FIG. 9, a block diagram of an exemplary cloud computing environment 900 is shown and described. The cloud computing environment 900 may include one or more resource providers 902a, 902b, 902c (collectively, 902). Each resource provider 902 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 902 may be connected to any other resource provider 902 in the cloud computing environment 900. In some implementations, the resource providers 902 may be connected over a computer network 908. Each resource provider 902 may be connected to one or more computing device 904a, 904b, 904c (collectively, 904), over the computer network 908.

The cloud computing environment 900 may include a resource manager 906. The resource manager 906 may be connected to the resource providers 902 and the computing devices 904 over the computer network 908. In some implementations, the resource manager 906 may facilitate the provision of computing resources by one or more resource providers 902 to one or more computing devices 904. The resource manager 906 may receive a request for a computing resource from a particular computing device 904. The resource manager 906 may identify one or more resource providers 902 capable of providing the computing resource requested by the computing device 904. The resource manager 906 may select a resource provider 902 to provide the computing resource. The resource manager 906 may facilitate a connection between the resource provider 902 and a particular computing device 904. In some implementations, the resource manager 906 may establish a connection between a particular resource provider 902 and a particular computing device 904. In some implementations, the resource manager 906 may redirect a particular computing device 904 to a particular resource provider 902 with the requested computing resource.

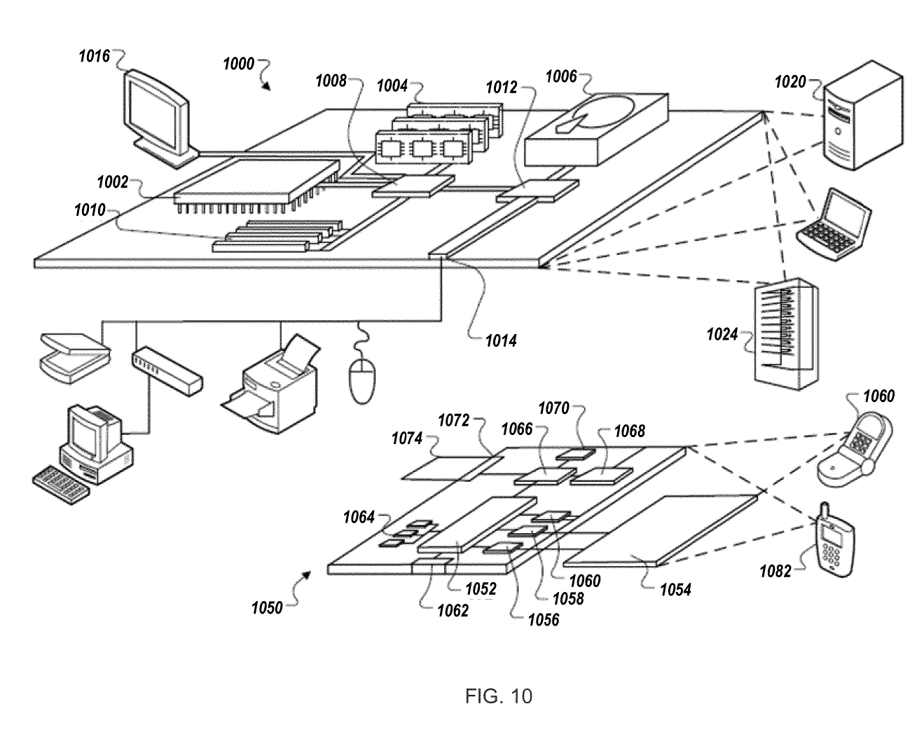

FIG. 10 shows an example of a computing device 1000 and a mobile computing device 1050 that can be used to implement the techniques described in this disclosure. The computing device 1000 is intended to represent various forms of digital computers, such as laptops, desktops, workstations, personal digital assistants, servers, blade servers, mainframes, and other appropriate computers. The mobile computing device 1050 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1004 stores information within the computing device 1000. In some implementations, the memory 1004 is a volatile memory unit or units. In some implementations, the memory 1004 is a non-volatile memory unit or units. The memory 1004 may also be another form of computer-readable medium, such as a magnetic or optical disk.

The storage device 1006 is capable of providing mass storage for the computing device 1000. In some implementations, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1002), perform one or more methods, such as those described above. The instructions can also be stored by one or more storage devices such as computer- or machine-readable mediums (for example, the memory 1004, the storage device 1006, or memory on the processor 1002).

The high-speed interface 1008 manages bandwidth-intensive operations for the computing device 1000, while the low-speed interface 1012 manages lower bandwidth-intensive operations. Such allocation of functions is an example only. In some implementations, the high-speed interface 1008 is coupled to the memory 1004, the display 1016 (e.g., through a graphics processor or accelerator), and to the high-speed expansion ports 1010, which may accept various expansion cards (not shown). In the implementation, the low-speed interface 1012 is coupled to the storage device 1006 and the low-speed expansion port 1014. The low-speed expansion port 1014, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device (not shown), such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chipset of chips that include separate and multiple analog and digital processors. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a TFT (Thin-Film-Transistor Liquid Crystal Display) display or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some implementations, or for wireless communication in other implementations, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a SIMM (Single In Line Memory Module) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provide as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1052), perform one or more methods, such as those described above. The instructions can also be stored by one or more storage devices, such as one or more computer- or machine-readable mediums (for example, the memory 1064, the expansion memory 1074, or memory on the processor 1052). In some implementations, the instructions can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1068 using a radio-frequency. In addition, short-range communication may occur, such as using a Bluetooth®, Wi-Fi™, or other such transceiver (not shown). In addition, a GPS (Global Positioning System) receiver module 1070 may provide additional navigation- and location-related wireless data to the mobile computing device 1050, which may be used as appropriate by applications running on the mobile computing device 1050.

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for providing sales analytics, including performance management and business planning reports, on a portable computing device are provided. Having described certain implementations of methods and apparatus for supporting sales analytics, including performance management and business planning reports, on a portable computing device, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

What is claimed:

1. A method for displaying and managing sales data on a portable computing device comprising:
receiving, at a portable computing device from a server via a network, sales information, wherein the sales information comprises sales data of one or more accounts associated with one or more sales representatives;
presenting, by a processor of the portable computing device, on a display of the portable computing device,
(a) at least a portion of the sales data, wherein the portion of the sales data is associated with at least one of the one or more accounts, and
(b) a control for managing the sales data, wherein the control for managing the sales data is configured upon selection to activate processing of the portion of the sales data according to one or more metrics identified via the control;
receiving selection of the control for managing data, wherein selection of the control activates processing of the portion of the sales data according to at least one metric of the one or more metrics; and
presenting, by the processor, on the display of the portable device, a subset of the sales data processed according to metrics provided via the control.

2. The method of claim 1, wherein activating processing comprises issuing a request to the server to process the portion of the sales data according to the at least one metric.

3. The method of claim 1, wherein the one or more metrics comprise at least one member selected from the group consisting of: (i) percentage of regional growth, (ii) percentage of regional revenue, (iii) sales opportunities, (iv) geography, (v) market share, (vi) a comparison of two or more accounts, (vii) growth over a specified period by at least one of market, product, competitor, and market share, and (viii) decline over a specified period by at least one of market, product, competitor, and market share.

4. The method of claim 1, wherein the control is configured for user selection of a particular metric of the one or more metrics.

5. The method of claim 4, wherein the control comprises one or more widgets for selection of the one or more metrics, wherein the one or more widgets comprise at least one member selected from the group consisting of: a button, a hyperlink, a drop-down list, a list box, a combo box, a check box, a radio button, a cycle button, a spinner, a menu, an icon, and a link.

6. The method of claim 1, further comprising:
receiving, by the processor, selection of a particular account of the one or more accounts; and
presenting, by the processor, a profile of the particular account, wherein the profile includes sales information associated with the particular account.

7. A method for displaying and managing sales data on a portable computing device comprising:
accessing sales information, wherein the sales information comprises sales data of a plurality of accounts associated with a plurality of sales representatives;
applying, by a processor of a computing device, one or more rules to the sales information to identify one or more accounts of the plurality of accounts, wherein the one or more accounts are associated with the sales information that satisfy at least one of the one or more rules;
creating, by the processor, one or more alert instances, wherein each alert instance of the one or more alert instances includes a respective identification of the respective account of the one or more accounts;
issuing, by the processor, the one or more alert instances to software application accounts of one or more sales representatives associated with the one or more accounts, wherein the one or more alert instances are configured to generate an alert via a respective software application installed upon a respective portable computing device;
receiving, by the processor, from a portable computing device via a network, a request responsive to a first alert instance of the one or more alert instances, wherein the request comprises a request for information associated with the first alert instance; and
providing, by the processor, to an application executing on the portable device, sales data associated with the first alert instance.

8. The method of claim 7, wherein applying the one or more rules to the sales information further comprises:
identifying, by the processor, a respective threshold associated with each rule of the one or more rules; and
comparing, by the processor, one or more values associated with the sales information to the respective threshold associated with each rule of the one or more rules to determine whether the sales information satisfies at least one of the one or more rules.

9. The method of claim 7, wherein the one or more rules comprise at least one member selected from the group consisting of: accounts that have the greatest opportunity, accounts declining, accounts growing, and contact frequency within a certain period of time.

10. The method of claim 7, wherein the sales data associated with the first alert instance comprises at least one member selected from the group consisting of: (i) percentage of regional growth, (ii) percentage of regional revenue, (iii) sales opportunities, (iv) geography, (v) market share, (vi) market volume change, (vii) contribution to geography in market value, (viii) market share change, (ix) comparison of two or more accounts, (x) growth over a specified period by market, product, competitor, or market share, and (xi) decline over a specified period by market, product, competitor, or market share.

11. The method of claim 7, wherein each alert instance of the one or more alert instances comprises an alert trigger description, wherein the alert trigger description identifies at least one of an identification of the one or more rules triggered, and a reason an alert was issued.

12. A non-transitory computer readable medium storing a set of instructions that, when executed by a processor, cause the processor to:
receive, at a portable computing device from a server via a network, sales information, wherein the sales information comprises sales data of one or more accounts associated with one or more sales representatives;
present, by a processor of the portable computing device, on a display of the portable computing device,
(a) at least a portion of the sales data, wherein the portion of the sales data is associated with at least one of the one or more accounts, and
(b) a control for managing the sales data, wherein the control for managing the sales data is configured upon selection to activate processing of the portion of the sales data according to one or more metrics identified via the control;
receive selection of the control for managing data, wherein selection of the control activates processing of the portion of the sales data according to at least one metric of the one or more metrics; and
present, by the processor, on the display of the portable device, a subset of the sales data processed according to metrics provided via the control.

13. The computer readable medium of claim 12, wherein activating processing comprises issuing a request to the server to process the portion of the sales data according to the at least one metric.

14. The computer readable medium of claim 12, wherein the one or more metrics comprise at least one member selected from the group consisting of: (i) percentage of regional growth, (ii) percentage of regional revenue, (iii) sales opportunities, (iv) geography, (v) market share, (vi) a comparison of two or more accounts, (vii) growth over a specified period by at least one of market, product, competitor, and market share, and (viii) decline over a specified period by at least one of market, product, competitor, and market share.

15. The computer readable medium of claim 12, wherein the control is configured for user selection of a particular metric of the one or more metrics.

16. The computer readable medium of claim 15, wherein the control comprises one or more widgets for selection of the one or more metrics, wherein the one or more widgets comprise at least one member selected from the group consisting of: a button, a hyperlink, a drop-down list, a list box, a combo box, a check box, a radio button, a cycle button, a spinner, a menu, an icon, and a link.

17. The computer readable medium of claim 12, further comprising storing a set of instructions that, when executed by a process, cause the processor to:
receive, by the processor, selection of a particular account of the one or more accounts; and
present, by the processor, a profile of the particular account, wherein the profile includes sales information associated with the particular account.

18. A non-transitory computer readable medium storing a set of instructions that, when executed by a processor, cause the processor to:
access sales information, wherein the sales information comprises sales data of a plurality of accounts associated with a plurality of sales representatives;
apply, by a processor of a computing device, one or more rules to the sales information to identify one or more accounts of the plurality of accounts, wherein the one or more accounts are associated with the sales information that satisfy at least one of the one or more rules;
create, by the processor, one or more alert instances, wherein each alert instance of the one or more alert instances includes a respective identification of the respective account of the one or more accounts;
issue, by the processor, the one or more alert instances to software application accounts of one or more sales representatives associated with the one or more accounts, wherein the one or more alert instances are configured to generate an alert via a respective software application installed upon a respective portable computing device;
receive, by the processor, from a portable computing device via a network, a request responsive to a first alert instance of the one or more alert instances, wherein the request comprises a request for information associated with the first alert instance; and
provide, by the processor, to an application executing on the portable device, sales data associated with the first alert instance.

19. The computer readable medium of claim 18, wherein applying the one or more rules to the sales information further comprises:
identifying, by the processor, a respective threshold associated with each rule of the one or more rules; and
comparing, by the processor, one or more values associated with the sales information to the respective threshold associated with each rule of the one or more rules to determine whether the sales information satisfies at least one of the one or more rules.

20. The computer readable medium of claim 18, wherein the one or more rules comprise at least one member selected from the group consisting of: accounts that have the greatest opportunity, accounts with market share or sales change, and contact frequency within a certain period of time.

21. The computer readable medium of claim 18, wherein the sales data associated with the first alert instance comprises at least one member selected from the group consisting of: (i) percentage of regional growth, (ii) percentage of regional revenue, (iii) sales opportunities, (iv) geography, (v) market share, (vi) market volume change, (vii) contribution to geography in market value, (viii) market share change, (ix) comparison of two or more accounts, (x) growth over a specified period by market, product, competitor, or market share, and (xi) decline over a specified period by market, product, competitor, or market share.

22. The computer readable medium of claim 18, wherein each alert instance of the one or more alert instances comprises an alert trigger description, wherein the alert trigger description identifies at least one of an identification of the one or more rules triggered, and a reason an alert was issued.
